(19) United States
(12) Patent Application Publication
(10) Pub. No.: US 2022/0294112 A1
(43) Pub. Date: Sep. 15, 2022

(54) UNIT CELL FOR A RECONFIGURABLE ANTENNA

(71) Applicant: ST Engineering iDirect, Inc. dba iDirect, Herndon, VA (US)

(72) Inventor: Ahmed KAUSAR, Fairfax, VA (US)

(21) Appl. No.: 17/679,717

(22) Filed: Feb. 24, 2022

(30) Foreign Application Priority Data
Feb. 25, 2021 (EP) 21159442.9

(51) Int. Cl. H01Q 5/30; H01Q 21/06; H01Q 5/10

(52) U.S. Cl. CPC H01Q 5/30; H01Q 21/065; H01Q 5/10

(57) ABSTRACT

A unit cell for a hybrid bifocal antenna includes a top conductor layer, a bottom conductor, and at least three inner conductor layers between the top conductor layer and the bottom conductor layer. The inner conductor layers are stacked on top of each other and each includes a substrate layer. An inner patch antenna element is present between adjacent substrate layers.

### FIELD OF THE INVENTION

The present invention is generally related to the field of reconfigurable antenna architectures for next generation satellite communication.

### BACKGROUND OF THE INVENTION

Low cost flat panel antennas are considered as an essential component for next generation satellite communication terminals. Depending on the distance from earth, satellites can be categorized as geostationary earth orbit satellite (GEO), medium earth orbit (MEO) and low earth orbit satellite (LEO). GEO satellites always appear stationary with respect to the Earth as their orbital period is synchronized with the Earth's rotation. An advantage of GEO satellites is that the ground station antennas do not need to track the satellite. GEO satellites orbit earth at a distance of 22,236 miles (35,785 km). Due to the high altitude GEO satellite communication has an inherent latency of at least 480 ms. Massive LEO/MEO constellations have been proposed for satellite communication. FIG. 1 shows a comparison of LEO, MEO and GEO constellations. LEO satellites orbit the earth at a distance between 250 to 1242 miles and MEO satellites orbit the earth at a distance between 1,242 to 22,236 miles. The orbits of LEO and MEO satellites are not synchronized with the earth's rotation. Therefore, ground terminal antennas are required to track the LEO/MEO satellites.

Antenna arrays (also named array antennas) are known in the art. Array antennas comprise a set of multiple connected sub-antenna elements which work together as a single antenna, to transmit or receive radio waves. The individual antenna elements of the array receive power from a transmitter or receiver by feedlines in a specific phase relationship.

Individual transmit and receive array antennas, referred to as transmitarrays and reflectarrays, respectively, have been known in the art since quite some time. The aperture of the transmitarray and reflectarray antennas comprises multiple unit cells, such that each unit cell can shift phase of the transmitted/reflected electromagnetic (EM) waves. The unit cells of the transmitarray antennas add phase shift to the transmitted EM waves, whereas the unit cells of the reflectarray antennas add phase shift to the reflected EM waves. The phase of the transmission coefficient of each unit cell in a transmitarray antenna aperture can be adjusted such that a directional beam is formed in the desired direction. Similarly, for the reflectarray antennas the phase of the reflection coefficient can be adjusted to form a beam in the desired direction. A transmitarray antenna can also be used to receive signals from the satellite, whereas a reflectarray can also be used for transmission to the satellite. Different techniques for individual transmitarray and reflectarray antenna designs have been proposed and extensively discussed in the literature. One of the reasons for this increased interest in transmitarray/reflectarray antennas is that such antennas can replace e.g. the conventional parabolic antennas on a satellite, which are quite bulky. In other words, a benefit in terms of mass and volume as well as in cost can be achieved.

In US2020/382206 a phased array antenna design is proposed for use in the antenna transmission and reception in Ku band frequencies. The input feed is split in a number of subfeeds. Such designs are expensive to implement due to the complex feed structure and they suffer from efficiency loss due to the splitting of the input feed. Moreover, phase shifter ICs are used for controlling phase shift of each sub antenna element. The cost of designing such an antenna can be high due to the presence of the phase shifter ICs.

Prior art disclosures like US2017/033462 A1 and EP3300172 A1 relate to a reconfigurable antenna comprising a transmitarray. In EP3300172 A1 SMD capacitors are used for adjusting the phase delay of the EM wave that passes through the unit cell, whereas in US2017/033462 A1 pin diodes are used for adjusting the phase delay of the EM wave that passes through the unit cell. FIG. 2 shows a unit cell of typical transmitarray antenna where a material 1302 with varying dielectric constant and/or capacitance is placed between top layer outer conductor patch 1301 and top layer inner conductor patch 1304. A bottom layer inner conductor patch 1305 and bottom layer outer conductor patch 1308 are shown as well. A substrate 1303 is positioned between the top and bottom layers. The unit cell of transmittarray antennas primarily adjusts the phase delay of the EM waves that passes through the unit cell. FIG. 3 shows a typical transmitarray antenna 1401 where antenna beam 1403 is formed in the opposite direction of the feedhorn 1402. For the antenna proposed in EP3300172 A1 a single reconfigurable beam is formed per aperture.

U.S. Pat. No. 9,048,544 B2 relates to a reconfigurable antenna comprising a reflectarray based on active integrated sub-antenna elements (AIA). Each unit cell consists of AIA formed by connecting a passive patch antenna element with an active circuit. CN110148841 A and the paper “A monolithically BST-Integrated Ka Band Beamsteerable Reflectarray Antenna” (K. Kalyan et al., IEEE Trans. Antennas and Propagation, Vol. 65, no. 1, January 2017, pp. 159-166) relate to reconfigurable reflectarray antennas. In the latter paper Barium Strontium Titanate composite (BST) is used for adjusting phase delay of the EM waves that are reflected by the unit cell. In CN 110148841A solid state plasma is used for adjusting phased delay of the EM waves that are reflected by the unit cell. FIG. 4 shows unit cell of typical reflectarray antennas where a material 1502 with varying dielectric constant and/or capacitance is placed between top layer outer conductor patch 1301 and top layer inner conductor patch 1504. A conductor ground plane 1305 is shown. A substrate 1503 is placed between the top layer and bottom ground plane. The unit cell of reflectarray antennas primarily adjusts the phase delay of the EM waves that are reflected by the unit cell. FIG. 5 shows typical reflectarray antenna where antenna beam 1603 is formed in the same direction as the feedhorn 1602 relative to the reflectarray meta-surface 1601. For the antenna proposed in the above-mentioned paper a single reconfigurable beam is formed per aperture.

The LEO/MEO mega constellations are expected to have frequent hand offs between satellites and multiple beam reconfigurable antennas are required at the user terminal for seamless satellite handoffs. Hence, there is a need to develop low cost multi-beam reconfigurable antennas. User terminals with such an antenna will enable provision of LEO/MEO based broadband to the consumer at affordable price points.

### SUMMARY OF THE INVENTION

It is an object of embodiments of the present invention to provide for a unit cell with a design that allows easy integration into a hybrid bifocal antenna. With hybrid bifocal antenna is meant an antenna that can be seen as a hybrid of a transmitarray and a reflectarray antenna. The hybrid bifocal antenna can operate simultaneously in a transmitarray mode for one frequency range and in a reflectarray mode for another frequency range.

The above objective is accomplished by the solution according to the present invention.

In a first aspect the invention relates to a unit cell for a bifocal antenna configured to operate, possibly simultaneously, as a transmitarray in a first frequency range and as a reflectarray in a second frequency range different from the first frequency range, comprising:
a top conductor layer comprising at least two concentric patch antenna elements, the outer patch antenna element of the top conductor layer being connectable to a top layer conductor line to receive a first voltage, said at least two patch antenna elements of the top conductor layer being connected via a first material with varying dielectric constant and/or capacitance when biased with the first voltage,
a bottom conductor layer comprising at least two concentric patch antenna elements, the outer patch antenna element of said bottom conductor layer being connectable to a bottom layer conductor line to receive a second voltage, said at least two patch antenna elements of the bottom conductor layer being connected via a second material with varying dielectric constant and/or capacitance when biased with the second voltage,
at least three inner conductor layers between the top conductor layer and the bottom conductor layer, said inner conductor layers being stacked on top of each other and each comprising a substrate layer, wherein an inner patch antenna element is present between consecutive substrate layers.

The proposed solution indeed allows for obtaining a unit cell that can be used as a building block for a hybrid bifocal antenna system. The design of the unit cell of the invention offers various options for optimization. For example, the number of concentric antenna elements of the top conductor layer and/or of the bottom conductor layer can be adapted as well as the number of inner conductor layers. Different materials with different dielectric constant and/or capacitance can be selected for the top conductor layer and bottom conductor layer. The proposed unit cell offers the advantage of a low cost solution, provided that a proper choice is made of the material between adjacent patch antenna elements.

In some preferred embodiments the top conductor layer, the bottom conductor layer or both comprise copper with a thickness of at least 1 μm, preferably at least 8 μm or at least 14 μm or at least 16 μm. A phase shift of the electromagnetic waves can be realized with the unit cell to steer the beam direction.

The at least two concentric patch antenna elements of the top conductor layer are connected via a first material with varying dielectric constant and/or capacitance when biased with a first voltage via the top layer conductor line. The at least two concentric patch antenna elements of the bottom conductor layer are connected via a second material with varying dielectric constant and/or capacitance when biased with a second voltage via the bottom layer conductor line. In some embodiments that second material may be the same as the material used between the at least two patch antenna elements of the top conductor layer. The second voltage may be equal to the first voltage or not. Between the consecutive substrate layers of the inner conductor layers an inner patch antenna element is provided. The inner conductor layers are configured for transmitting an incoming electromagnetic signal in a first frequency range in a transmit beam and for receiving an incoming electromagnetic signal in a frequency range different from the first frequency range in a receive beam. The unit cell is so made adapted for use in a hybrid bifocal antenna, i.e. a bifocal antenna that can simultaneously act as reflectarray in one frequency range and as transmitarray in another frequency range. It may be advantageous in some embodiments to have more than three inner conductor layers. A transmitarray antenna can also be used to receive signals from the satellite, whereas a reflectarray can also be used for transmission to the satellite.

The concentric patch antenna elements may have various shapes, for example they may be circular, square, elliptical, rectangular or polygon shaped, without being limited thereto. When used in an antenna system comprising a multitude of unit cells, it is not required that the concentric patch antenna elements in all unit cells have the same shape.

In some embodiments the unit cell comprises at least one via between the top conductor layer and the bottom conductor layer.

In some embodiments the top layer conductor line has a reactive impedance of at least 500 Ohm, preferably about 900 Ohm, in its frequency range of operation. In some embodiments the bottom layer conductor line has a reactive impedance of at least 500 Ohm, preferably about 900 Ohm, in its frequency range of operation.

Advantageously, the inner patch antenna elements between the substrate layers of the at least three inner conductor layers are made of or coated with copper, aluminium, silver or gold. The same material can also be used for the top and/or the bottom layer. In certain embodiments other conductive material(s) may be used for the patch antenna elements.

The material connecting the at least two concentric patch antenna elements of the top conductor layer and/or of the bottom conductor layer, is a composite, an integrated circuit, a diode or a liquid crystal polymer. A preferred material is a Barium Strontium Titanate composite, which yields a low cost solution.

In one embodiment all of the inner conductor layers have a homogeneous substrate layer with a same dielectric constant. In another embodiment at least two of the inner conductor layers have a substrate layer in a different material and with a different dielectric constant.

In another aspect the invention relates to a bifocal antenna assembly comprising a plurality of unit cells as previously described.

The various unit cells each have at least three inner conductor layers and are adapted to transmit an incoming electric signal in a first frequency range and to receive, even simultaneously with the transmitting, an incoming electromagnetic wave signal in a second frequency range. In some embodiments one frequency range comprises frequencies between 17.8 and 20.2 GHz for reflectarray mode operations and the other frequency range comprises frequencies between 27.5 and 31 GHz for transmitarray mode operations.

In embodiments the antenna assembly is arranged to receive bias voltages for each unit cell of the plurality of unit cells. Advantageously the antenna assembly comprises an antenna controller for generating the bias voltages.

In embodiments the antenna assembly comprises a first feed positioned at one side of the antenna surface at a distance of 0.8 times the antenna diameter and a second feed positioned at the opposite side of the antenna surface at a distance of 0.8 times the antenna diameter.

In some embodiments the antenna assembly comprises a first and a second feed positioned at variable distance from the respective antenna surfaces.

In a further aspect the invention relates to a method for operating a unit cell as previously described. The method comprises

transmitting with the unit cell an incoming electric signal in a first frequency range in a transmit beam, or

receiving with the unit cell an incoming electromagnetic wave signal in a second frequency range in a receive beam.

In advantageous embodiments the transmitting the incoming electric signal in the first frequency range and receiving the incoming electromagnetic wave signal in the second frequency range occurs simultaneously.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, wherein like reference numerals refer to like elements in the various figures.

FIG. 1 illustrates the difference between LEO, MEO and GEO satellites.

FIG. 2 illustrates a unit cell of a conventional transmitarray antenna.

FIG. 3 illustrates a conventional transmitarray antenna.

FIG. 4 illustrates a unit cell of a conventional reflectarray antenna.

FIG. 5 illustrates a conventional reflectarray antenna.

FIG. 6 illustrates a unit cell according to embodiments of the present invention.

FIG. 7 illustrates a network providing the bias voltages to a plurality of unit cells.

FIG. 8 illustrates an RLC circuit equivalent to a unit cell.

FIG. 9 illustrates the phase shift at a unit cell i due to spatial distribution.

FIG. 10 illustrates a top view of an embodiment of a hybrid bifocal antenna.

FIG. 11 illustrates an embodiment of a hybrid bifocal antenna.

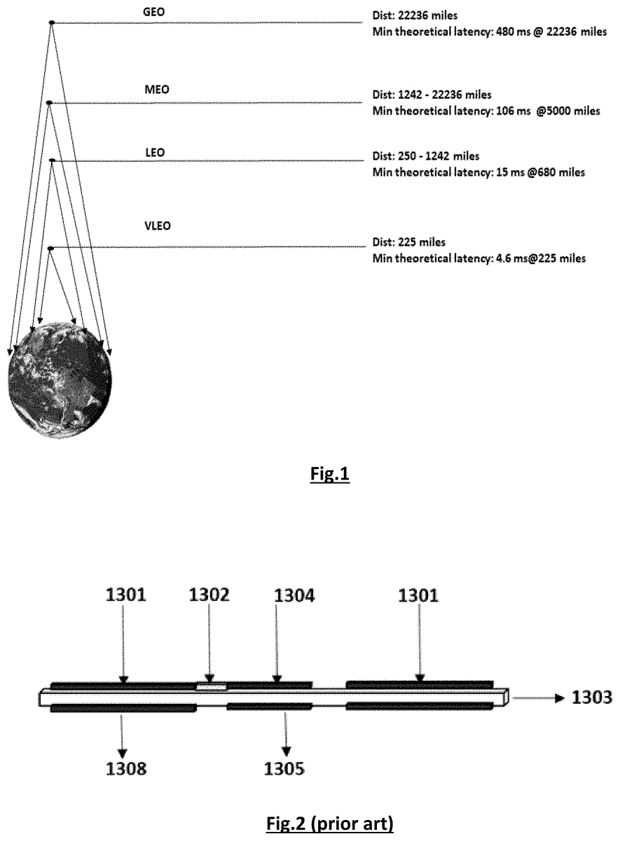

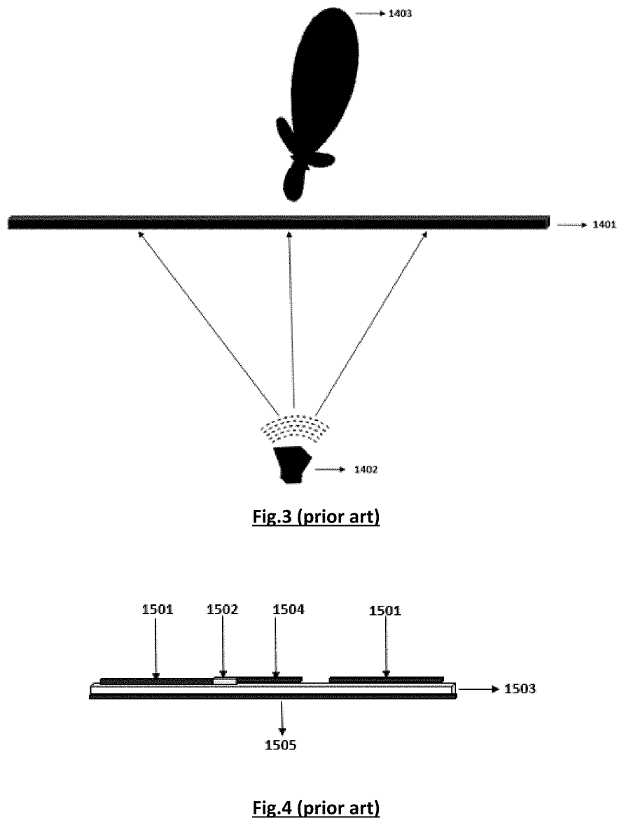

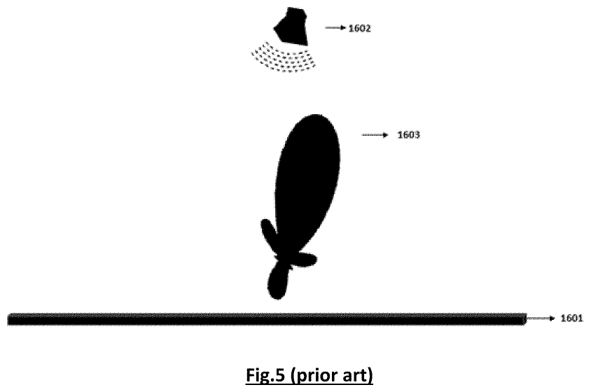

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention discloses systems to steer the radiation pattern of a reconfigurable antenna, primarily for use in the Ka band. The Ka band in satellite communication typically covers frequencies from 27.5 to 31 GHz for uplink communication from a ground station to satellite and 17.8 to 20.2 GHz for downlink communication from satellite to a ground station. With ‘reconfigurable’ antenna is meant that at least one characteristic of the antenna can be modified during its lifetime, after the manufacturing thereof. Such an antenna is implemented as an antenna system comprising a plurality of unit cells. In a first aspect the invention relates to a unit cell for a bifocal antenna capable of, possibly simultaneously, working in a so called transmitarray mode for a first range of frequencies and in a so called reflectarray mode for another range of frequencies. In transmitarray mode the antenna operates as a transmitarray, whereas in reflectarray mode it operates as a reflectarray. In a further aspect the invention relates to a bifocal antenna assembly comprising a multitude of such unit cells.

In a first aspect the unit cell comprises a top conductor layer, a bottom conductor layer and at least three inner conductor layers between the top conductor layer and the bottom conductor layer. The top conductor layer comprises at least two concentric patch antenna elements. Also the bottom conductor layer comprises at least two concentric patch antenna elements. With patch antenna element is meant a microstrip antenna element with a low profile which can be mounted on a flat surface. It usually is fabricated using photolithographic techniques on a printed circuit board. The concentric patch antenna elements may have various shapes, for example circular, square, rectangular, elliptical or polygon. A circular shape is advantageous in that this shape provides lower reflection and transmission losses. The antenna elements are made of a conductive material. Any appropriate conductive material can be used, e.g. copper, silver, aluminium or gold without being limited thereto. Adjacent concentric antenna elements are connected via a material with variable dielectric constant and/or variable capacitance. The material can for example be a composite, an integrated circuit (IC), a diode or liquid crystal polymer attached to or sandwiched between the concentric patches. Electrical properties of these materials change with the bias voltage being applied. The composite, IC, diode or liquid crystal polymer can have a variable dielectric constant and/or capacitance. As a result, these materials can provide a shift in phase and/or amplitude to the impinging electromagnetic waves. In some preferred embodiments the material between the concentric patches is Barium Strontium Titanate (BST), which has a low fabrication cost and offers design flexibility. Bifocal antennas with BST material can be manufactured by using conventional printed circuit board (PCB) fabrication techniques. Liquid crystals polymer based reflectarray antennas have low power consumption and are suited for high frequency applications.

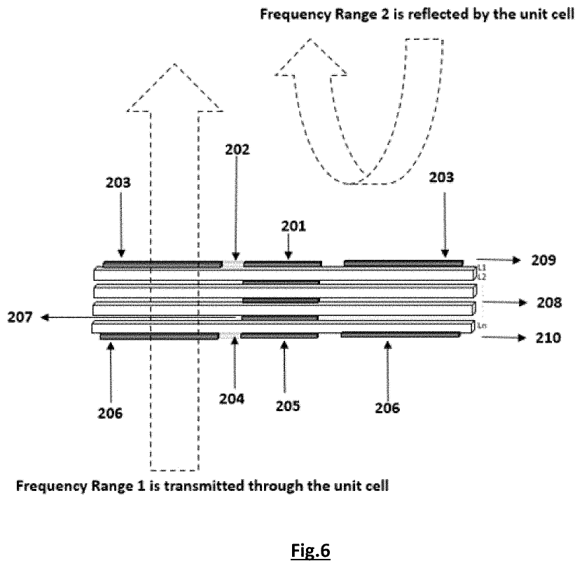

FIG. 6 represents in cross-section an illustration of an embodiment of a unit cell according to the invention. The unit cell comprises a top conductor layer 209 and a bottom conductor layer 210. The top conductor layer comprises at least an inner patch antenna element 201 and an outer conductor patch, see antenna element 203 in FIG. 6, arranged concentrically around the inner conductor patch 201. The unit cell comprises at least three inner conductor layers 208 between the top conductor layer 209 and the bottom conductor layer 210, each inner conductor layer comprising a substrate layer. These layers of substrate 208 may be all in a same material, so that they all have a same dielectric constant. Alternatively, at least two of the substrate layers may be in a different material with different dielectric constants. In FIG. 6 n inner conductor layers L₁, L₂, . . . , Lₙ (with n>2) are depicted. The inner layers are stacked on top of each other such that between two consecutive substrate layers 208 a conductive layer is sandwiched, e.g. a copper layer, that forms an inner patch antenna element 207. The inner conductor layers provide mutual coupling between the inner surfaces and reduce losses. The planar patches between adjacent substrate layers of the inner conductor layers are of e.g. circular, rectangular or square shape or any other shape. The bottom conductor layer comprises at least an inner patch antenna element 205 and an outer conductor patch, see antenna element 206 in FIG. 6, arranged concentrically around the inner conductor patch 205.

Various substrate materials can be used for the substrate layers 208 of inner conductor layers L1, L2 and L3. In some embodiments the substrate layers may for example be a Rogers RO 4835 laminate (i.e. a high frequency circuit material that can operate up to 40 GHz) or a combination of Rogers 4835 and Rogers 5880. They are advantageous materials because they have shown low RF losses at the Ka band. In general, any PCB material that has a low loss tangent and dielectric constant can be used as a substrate, for example, Rogers CuClad 217, Rogers Duriod 6002 etc.

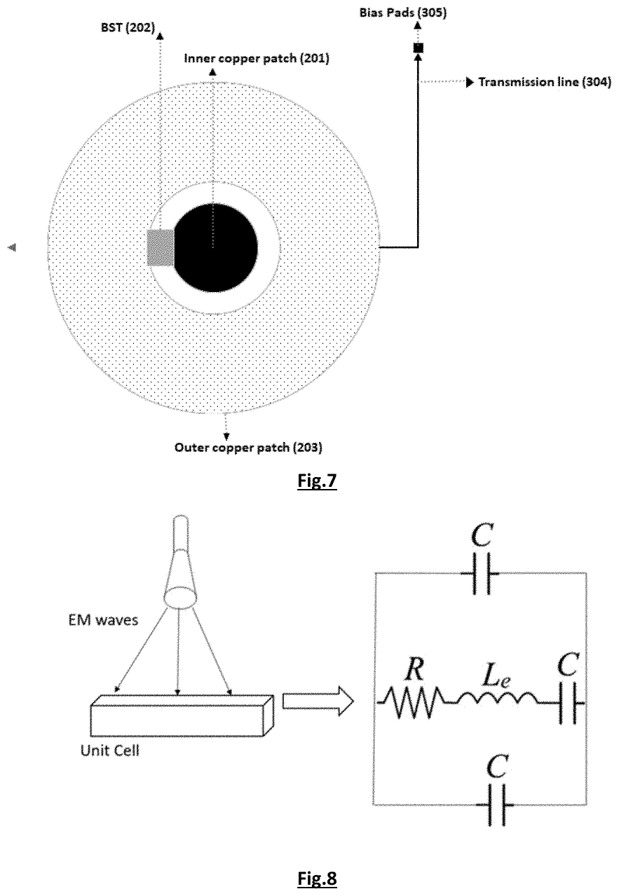

The outer patch antenna element of the top conductor layer and the outer patch antenna element of the bottom conductor layer can be connected to a top layer conductor line and bottom layer conductor line, respectively, to receive a respective bias voltage. The bias voltage is used to tune the unit cell. The bias voltages are provided to the outer surfaces of the top layer concentric patches and to the outer surfaces of the bottom layer concentric patches (see below), through a voltage distribution network. The inner patch antenna elements of the unit cell are connected with DC ground. An illustration is given in FIG. 7. The top view depicted in FIG. 7 shows two concentric patch antenna elements implemented as an outer copper ring (203) and an inner copper ring (201). The material in between the copper rings is in this example a BST deposition (202). A bias pad (305) is provided for supplying a voltage via a voltage distribution line (304) of the voltage distribution network, i.e. via a transmission line.

In preferred embodiments the length and thickness of the voltage distribution lines are selected such that each line has a high reactance, for example a reactance of at least 500 Ohm, preferably at least 900 Ohm. For example at 17.8 GHz the voltage distribution line provides an inductive reactance of about 900 Ohm. In some embodiments the width of the conductor lines along which the voltage is distributed, is at most 0.1 times wavelength λ and the height is at most 0.03λ, with λ=c/f and f is the lowest frequency in the considered frequency range. A high reactance ensures the RF signal is isolated from the DC voltage distribution network and minimizes the RF leaking into the bias network. The inductance of a microstrip transmission line is calculated as:

$$Inductance ( µH ) = 0.005 \; 08 * Len [ ln ( \frac{2 Len}{Widt h + H e i g h t} ) + 0.5 + 0.2 \; 235 ( \frac{Width + Height}{Len} ) ]$$

where Len denotes the transmission line length, Width the transmission line width, Height the substrate thickness. The inductive impedance X_{L} is calculated as X_{L}=jωL, wherein L represents the transmission line inductance.

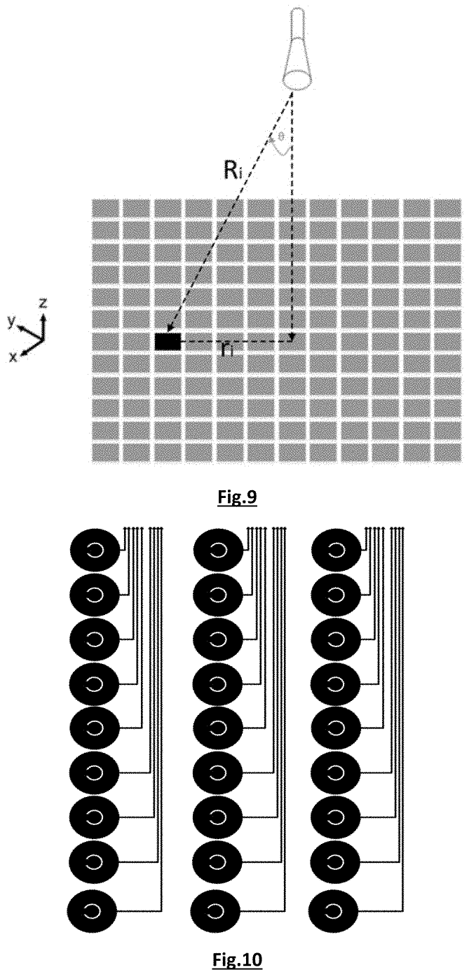

Electrically a unit cell can be seen as an equivalent of a RLC circuit as shown in FIG. 8. The circuit comprises a branch with a series connection of a resistor R, an inductor Le and a capacitor C in parallel with two branches with a capacitance C. Both in the top conductor layer and in the bottom conductor layer one can change the phase and/or amplitude of the transmitted/reflected signal by changing via the applied bias voltage the capacitance across the unit cell and/or the dielectric constant of the unit cell.

FIG. 9 shows spatial phase shift at a unit cell i that is at a distance of Rᵢ from the feed horn, θ_{R} (xᵢ, yᵢ), at each unit cell in x,y axis is calculated as

θ_{R}(xᵢ,yᵢ)=K₀[Rᵢ−xᵢ sin θ₀ cos Ø₀−yᵢ sin θ₀ sin Ø₀]

Rᵢ=\sqrt{(xᵢ−xₒ)²+(yᵢ−y₀)²+(z₀)²}

where the feed horn is placed at (x₀,y₀,z₀), Rᵢ denotes the distance from the feed horn to the i^{th} unit cell with position (xᵢ,yᵢ,zᵢ) that is being considered, rᵢ the distance of said i^{th} unit cell to the centre of the surface having coordinates (x₀,y₀,0), K₀ the angular wavenumber equal to 2π/k. θ₀ is the desired elevation angle and φ₀ the desired azimuth angle.

The geometry of the unit cell is preferably selected such that a continuous phase shift between 0° and 360° can be achieved for the transmission and/or reflection coefficients. Five (in case of a configuration with a top conductor layer, three inner conductor layers and a bottom conductor layer) or more layers of the conductive materials are used in the unit cell. Multiple layers make the design broadband and reduce RF losses. Moreover, by using the multiple layers of conductive material and substrate the range of the phase shift provided by each unit cell is increased. The concentric patch pattern provides a simple and effective mechanism for adding a material with varying dielectric constant and/or capacitance to the unit without adversely affecting the magnitude of the reflection/transmission coefficients.

Further, the unit cell dimensions may be optimized such that the magnitude of the reflection and/or transmission coefficient is less than predetermined threshold, for example 5 or 7 dB, within the conventional Ka band frequency ranges. By using the multi-layer geometry, concentric antenna elements can keep the magnitude of the reflection and transmission coefficients below said threshold level (e.g. 5 or 7 dB) for all the phase shift values. It is important to have low magnitude of reflection/transmission coefficients for maintaining optimal aperture efficiency.

The etching pattern with two or more concentric antenna elements and a material deposited in between adjacent elements can be applied in unit cells of an individual bifocal antenna that can operate simultaneously as transmitarray and as reflectarray. As already mentioned, in preferred embodiments the material may be a BST layer. The top view shown in FIG. 10 is a top-view of a bifocal antenna.

The antenna assembly may in some embodiments further comprise a spatial feed, for example a horn. The patch antennas of the bottom conductor layer receive the incident electromagnetic wavefronts emitted by the feed horn. The patch antennas of the top conductor layer form the transmit surface.

The design of the top conductor layer and the bottom conductor layer is symmetrical in some embodiments. In other embodiments, however, there may be differences between the top conductor layer and the bottom conductor layer. It may even be advantageous to have a certain asymmetry between the top layer and the bottom layer to allow operation in two different frequency ranges.

In embodiments of the unit cell of the invention the at least two concentric patch antenna elements of the top layer are connected via a first material with varying dielectric constant and/or capacitance when biased with a first voltage via the top layer conductor line and the at least two concentric patch antenna elements of the bottom layer are connected via a second material with varying dielectric constant and/or capacitance when biased with a second voltage via the bottom layer conductor line. The material may in preferred embodiments be the same material on the top layer and on the bottom layer. In other embodiments, however, the material between the concentric patch elements of the bottom layer is different from the material used between the concentric patch elements of the top layer. In some embodiments it may occur that a BST layer is present between the two concentric patches provided at the top and/or bottom conductor layer.

By providing between the top and bottom layer in such a unit cell at least three inner layers, each comprising a substrate layer and having an inner patch antenna element in between adjacent substrate layers, the unit cell can simultaneously operate in transmitarray mode, whereby an incoming electric signal is transmitted in a transmit beam in a first frequency range, and in reflectarray mode, wherein an incoming electromagnetic wave signal in a second frequency range is received in a receive beam. This is illustrated in FIG. 6. The two frequency ranges are different from each other. In some preferred embodiments one frequency range covers receive Ka band frequencies and the other frequency range covers transmit Ka band frequencies. The top layer and the bottom layer are arranged to provide a response at specific frequency ranges. Inner layers resonate at both frequency bands and they help to improve bandwidth, minimize RF losses and increase phase shift range. The size of the concentric patch antenna elements depends on the frequency over which transmit/receive antenna is to be operable.

Having multiple inner layers allows obtaining a unit cell that can resonate to a broad range of frequencies. In some embodiments of the unit cell it is therefore advantageous to have more than three inner conductor layers, for example 7 or 9 or 11 or more layers, each comprising a substrate layer and provided with an inner patch antenna between adjacent substrate layers.

The layers of substrate may be in a material having a same or a different dielectric constant, as already mentioned previously. In other words, the substrate may be homogeneous or non-homogeneous. In one embodiment all substrate layers are in a RO4835 laminate. In another embodiment a multi-layer substrate with layers in either RO4835 or in RO5870 can be applied.

In some embodiments of a unit cell for a bifocal antenna one or more vias may be provided between the top conductor layer and the bottom conductor layer.

In another aspect the invention relates to a bifocal antenna assembly that can act simultaneously as transmitarray in a transmitarray mode and as reflectarray in a reflectarray mode and comprises a multitude of unit cells. The unit cells each comprise at least three inner conductor layers with an inner patch antenna element between adjacent substrate layers. In other words, there are at least two inner patch antenna elements. The three layers are needed to allow for the operation in two different frequency ranges as discussed previously. The proposed design has two independently steerable beams each covering a different frequency range. The antenna assembly is capable of transmitting an incoming electric signal in a first frequency range in a transmit beam and simultaneously receiving an incoming electromagnetic wave signal in a second frequency range in a receive beam. The antenna assembly can steer the transmit beam and the receive beam independently by shifting the phase of the reflected and transmitted waves in the unit cells. The phase shifting may possibly be different in each of the unit cells. A transmitarray antenna can also be used to receive signals from the satellite, whereas a reflectarray can also be used for transmission to the satellite.

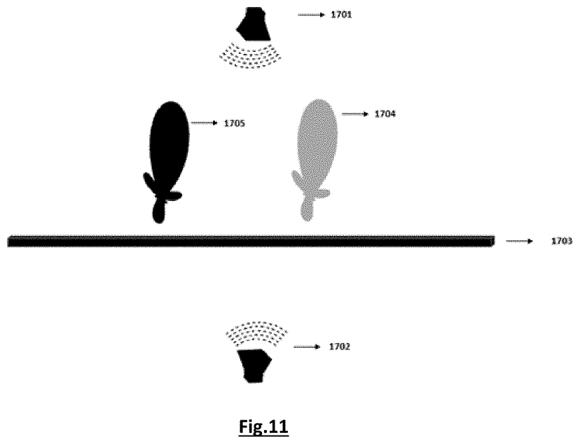

FIG. 11 provides an illustration of antenna assembly that can act simultaneously as transmitarray and as reflectarray antennas. Surface 1703 comprises a plurality of unit cells as described above. The unit cells form the grid points of the antenna assembly. The assembly may further comprise spatial feeding through feed horns, for example a transmitarray feed horn 1702 and a reflectarray feed horn 1701. In the embodiment depicted in FIG. 11 a reflectarray feed horn (for use in e.g. a 20 GHz receive chain) and a transmitarray feed horn (for use in e.g. a 30 GHz transmit chain) are depicted as an example.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A unit cell for a bifocal antenna, comprising:
a top conductor layer comprising at least two concentric patch antenna elements, an outer patch antenna element of the top conductor layer being connectable to a top layer conductor line to receive a first voltage, said at least two concentric patch antenna elements of the top conductor layer being connected via a first material with varying dielectric constant and/or capacitance when biased with the first voltage,
a bottom conductor layer comprising at least two concentric patch antenna elements, the outer patch antenna element of said bottom conductor layer being connectable to a bottom layer conductor line to receive a second voltage, said at least two patch antenna elements of the bottom conductor layer being connected via a second material with varying dielectric constant and/or capacitance when biased with the second voltage,
at least three inner conductor layers between the top conductor layer and the bottom conductor layer, said inner conductor layers being stacked on top of each other and each comprising a substrate layer, wherein an inner patch antenna element is present between consecutive substrate layers,
wherein the unit cell is configured to transmit an incoming electric signal in a first frequency range in a transmit beam and to receive an incoming electromagnetic wave signal in a second frequency range in a receive beam.

2. The unit cell as in claim 1, comprising at least one via between the top conductor layer and the bottom conductor layer.

3. The unit cell as in claim 1, wherein the concentric patch antenna elements are circular, square, elliptical, rectangular or polygon shaped.

4. The unit cell as in claim 1, wherein the top layer conductor line has a reactive impedance of 900 Ohm in its frequency range of operation.

5. The unit cell as in claim 1, wherein the first material and/or the second material is a composite, an integrated circuit, a diode or a liquid crystal polymer.

6. The unit cell as in claim 5, wherein the composite is a Barium Strontium Titanate composite.

7. The unit cell as in claim 1, wherein each of the inner conductor layers has a same substrate with a same dielectric constant.

8. The unit cell as in claim 1, wherein the first material and the second material are the same.

9. The unit cell as in claim 1, wherein the first voltage and the second voltage are the same.

10. The unit cell as in claim 1, wherein said top conductor layer and/or said bottom conductor layer has a thickness of at least 1 μm.

11. An antenna assembly comprising a plurality of unit cells as in claim 1.

12. The antenna assembly as in claim 11, wherein said first frequency range comprises frequencies between 27.5 and 30 GHz and said second frequency range comprises frequencies between 17.8 and 20.2 GHz.

13. The antenna assembly as in claim 11, arranged to receive a bias voltage for each unit cell of said plurality.

14. The antenna assembly as in claim 13, comprising an antenna controller for generating said bias voltages.

15. The antenna assembly as in any of claim 11, comprising a first feed positioned at one side of an antenna surface at a distance of substantially 0.8 times the antenna diameter and a second feed positioned at the opposite side of the antenna surface at a distance of substantially 0.8 times the antenna diameter.

16. The antenna assembly as in any of claim 11, comprising a first and a second feed positioned at variable distance from the respective antenna surfaces.

17. A method for operating a unit cell having a top conductor layer comprising at least two concentric patch antenna elements, an outer patch antenna element of the top conductor layer being connectable to a top layer conductor line to receive a first voltage, said at least two concentric patch antenna elements of the top conductor layer being connected via a first material with varying dielectric constant and/or capacitance when biased with the first voltage, a bottom conductor layer comprising at least two concentric patch antenna elements, the outer patch antenna element of said bottom conductor layer being connectable to a bottom layer conductor line to receive a second voltage, said at least two patch antenna elements of the bottom conductor layer being connected via a second material with varying dielectric constant and/or capacitance when biased with the second voltage and at least three inner conductor layers between the top conductor layer and the bottom conductor layer, said inner conductor layers being stacked on top of each other and each comprising a substrate layer, wherein an inner patch antenna element is present between consecutive substrate layers, the method comprising:
transmitting with the unit cell an incoming electric signal in a first frequency range in a transmit beam, or
receiving with the unit cell an incoming electromagnetic wave signal in a second frequency range in a receive beam.

18. The method for operating a unit cell as in claim 17, wherein transmitting the incoming electric signal in the first frequency range and receiving the incoming electromagnetic wave signal in the second frequency range occurs simultaneously.
